(19) United States
(12) Patent Application Publication
(10) Pub. No.: US 2002/0181534 A1
(43) Pub. Date: Dec. 5, 2002

(54) Diode-pumped slab solid-state laser

(75) Inventors: Norman Hodgson, San Francisco, CA (US); Hanna J. Hoffman, Palo Alto, CA (US)

Correspondence Address: WILSON SONSINI GOODRICH & ROSATI, 650 PAGE MILL ROAD, PALO ALTO, CA, 943041050

(73) Assignee: Spectra-Physics Lasers, Inc., Mountain View, CA

(21) Appl. No.: 10/035,805

(22) Filed: Oct. 25, 2001

Related U.S. Application Data
(60) Provisional application No. 60/243,514, filed on Oct. 25, 2000.

(51) Int. Cl. H01S 3/06

(52) U.S. Cl. 372/66

(57) ABSTRACT

A solid state laser in which a slab of lasing material is held within an optical resonator is disclosed. The length of the slab in parallel to the optical axis of the resonator is between 5 and 1,000 mm, the width and thickness of the slab are 1-50 mm and 0.01-2 mm, respectively. The slab is designed in a way that causes the pump light to be confined when side- or end pumped by diode lasers. This is accomplished by either polishing the two largest area faces (referred to as upper and lower sides) of the slab and coating them with a material (dielectric or metallic) that is highly reflective at the emission wavelength, or by sandwiching the slab between dielectric materials that comprise a lower refractive index compared to the index of the slab. In alternative embodiments, the thin dimension of the slab may be selected so as to either guide the signal light or to allow free space propagation. In either case, resonator designs are described that provide high brightness beams in two dimensions, regardless of the slab aspect ratio. The side faces of the slab may be polished and AR coated at the solid state laser emission wavelength. Pumping light from an emission line of semiconductor lasers is allowed to enter the slab through at least one of the slab's side faces. By choosing the slab dimensions and the doping concentration of the slab material correctly, efficient absorption of the pump light is achieved. The slab is thermally controlled by cooling its upper and/or lower side. Cooling methods may include direct water cooling or conduction cooling through a metal structure that is in contact with the upper or lower slab side.

### PRIORITY CLAIM

This application claims the benefit of U.S. Provisional Application No. 60/243,514, filed on Oct. 25, 2000. Further, this application incorporates herein the entirety of application Ser. No. 60/243,514 by reference.

### FIELD OF THE INVENTION

This invention relates to diode-pumped solid state lasers and more particularly to a diode-pumped solid state laser having an output of high beam quality and high brightness.

### BACKGROUND OF THE INVENTION

Diode-pumped solid state lasers have been used in applications that require high output power and high beam quality. In standard laser configurations, cylindrically shaped or rectangularly shaped active materials are held within an optical resonators and are side- or end pumped by diode lasers, fiber coupled diode lasers, or diode laser bars [1]. In both geometries, typical dimensions of the active material are on the order of 1-10 mm in both directions perpendicular to the optical axis. It is well known that these configurations exhibit a limitation in regards to output power and beam quality. For typical crystalline laser rods, such as YAG, fracture occurs when the output power exceeds about 60 W per cm of length. The fracture limit is still lower for other materials such as YVO₄ and YLF. For single mode operation, as provided for example by the TEM₀₀ mode of a stable resonator, the output power is further limited due to beam size considerations. Thus, it is generally known in the art that even for a high gain material such as Nd:YVO₄, the TEM₀₀ power is limited to less than about 40 W per rod, when the resonator is required to be stable over the entire pump power range. For rods of the lower gain, such as the commonly utilized Nd:YAG, the power limit for TEM₀₀ operation reduces to less than about 25 W. Higher TEM₀₀ mode output powers from rod geometries can be achieved only by limiting the pump power range over which the resonator is stable. Consequently, the axially symmetric rod geometry fundamentally limits the attainable output power for high brightness beams.

A more favorable geometry is provided by rectangularly shaped slabs. The fracture limit of slab lasers is known to be higher compared to a rod by the aspect ratio a/2b where a is the width of the slab and b is its thickness. This is the result of larger surface to volume ratio and smaller temperature gradients across the thinner dimension. The larger the aspect ratios the more favorable the heat dissipation profiles, allowing slabs to provide correspondingly higher maximum output powers compared to a cylindrical or near-square rod geometry. However, the slab output power in TEM₀₀ mode is still limited, due to a mismatch between the mode and the slab dimensions, which typically have cross sections on the order of 5×20 mm. This mismatch could, in principle, be overcome by using unstable resonators, which have the unique property that near diffraction limited beam quality can be attained regardless of the transverse dimensions of the active medium. However, even with unstable resonators, near single mode performance from slab lasers has been disappointing. The difficulties were attributed primarily to edge effects and residual optical aberrations due to thermal strain caused by pumping and cooling induced nonuniformities.

One approach to improve the beam quality from slab lasers included the use of planar waveguide lasers with aspect ratios large enough to allow one dimensional temperature gradients and thin enough to avoid deleterious edge effects. A waveguide laser differs from a conventional laser in that the circulating light is guided over a portion of the propagating path and does not obey the laws of free space propagation. Such configurations have been successfully employed in sealed CO₂ lasers. A waveguide slab CO₂ laser is generally configured with electrode separation small enough to cause waveguiding of the laser beam along only one dimension of the discharge volume, while propagating freely in the wider dimension. The large aspect ratios common in this type of laser result in very different mode properties in the x and y directions. This led to development of hybrid resonator designs characterized by optical configurations that are stable in one direction and unstable in the perpendicular direction.

For example, U.S. Pat. No. 4,719,639 issued to Tulip discloses a CO₂ slab waveguide laser comprising an unstable resonator structure in the unconfined direction but a stable waveguide resonator in the guided direction. The unstable resonator described by Tulip includes one concave and one convex mirror and is known in the art as a positive branch unstable resonator. Another slab waveguide resonator structure was described in U.S. Pat. No. 4,939,738 issued to Opower which was also provided with a positive branch unstable resonator in the nonwaveguide direction. By contrast, U.S. Pat. No. 5,335,242 issued, for example, to Hobart et al and U.S. Pat. No. 5,353,297 issued to Koon et al disclose CO₂ slab waveguide lasers having a negative branch unstable resonator in the nonwaveguiding direction. Such resonator constructions allow the resonator mirrors to be spaced sufficiently apart from the ends of the guide to provide more optimal coupling of the circulating laser light into the guide while minimizing mirror degradations due to the discharge. Negative branch unstable resonators are also known to be less alignment sensitive than their positive branch counterparts, as is well known in the art. Constructions based on both positive-branch and negative branch resonators were successfully implemented in commercial packages for different sealed-off CO₂ slab lasers, depending on power levels and size requirements. High average powers (up to 2.5 kW) with good beam quality characteristics are now available from commercial CO₂ lasers such as the Diamond Model manufactured by Coherent.

More recently, waveguide lasers have also been demonstrated as an efficient means to generate high brightness output beam from solid state media [3-9]. In this case, sandwiching the waveguide slab between one or more matching stacks of dielectric materials can be used to confine the pump light if one of the materials exhibits a lower index of refraction than the active laser material (dielectric waveguide). If, in addition, the Fresnel number—defined as a²/λL—is much smaller than unity, the laser, or signal beam is guided along the thin direction. For typical solid state gain media, the emission wavelength is near 1 μm. Therefore the waveguide slab geometry for solid state gain media generally requires a thickness smaller by about an order of magnitude than the 1-2 mm typically utilized for 10 μm CO₂ lasers of similar length. In addition, dielectric waveguides do not provide the transverse mode discrimination available from the metallic or ceramic coated waveguides used for CO₂ and other gas lasers. Consequently, single mode waveguides are generally required for extraction of good beam quality from solid state planar dielectric waveguide lasers. To force laser oscillation in the lowest order mode means that the thickness of the active slab laser material must therefore be limited to 5-10 times the laser emission wavelength, i.e., less than 10 microns for standard 1 μm Nd or Yb-doped active media. Such thin waveguide constructions are considered especially advantageous for high threshold and/or low gain systems, such as the quasi-three level Yb:YAG, as it is well known in the art that smaller dimensions can help lower thresholds while improved overlap between the pump, and signal radiation provides for longer interaction lengths and higher efficiency. Since planar configurations also provide a good match to diode-bar pump lasers, there have been considerable recent investigations into various diode pumped crystalline waveguide structures, emphasizing improved efficiency and beam quality aspects for diode pumped, lower gain solid state lasers. For example, over 12 W were demonstrated recently from planar waveguide lasers based on composite structures of diffusion-bonded Yb:YAG crystal, using a 8 μm single mode active core surrounded by double-clad structure and pumped by 40 W diode bar [10].

Considerable further power scaling from such cladding-pumped waveguide structures may however, be gain limited. In particular, as pump powers approach 50 W, gains from ultra thin structures may become too high to sustain efficient single mode laser oscillation, due to parasitic oscillations and amplified stimulated emission (ASE) effects. This is especially an issue for higher gain media such as Nd:YAG, where ASE losses may become manifest with less than 20 W pump power input into a 10 μm thin waveguide. Recent experiments with diode pumped diffusion bonded multimode 80×100 μm waveguide Yb-doped YAG [6] indicate that ASE losses may become a limiting factor even for this much lower gain material as evidenced by the 50% output coupling required to optimize output powers in this work. Parasitics and ASE losses represent even more of an issue for pulsed operation, where overly high gains may prevent Q-switch hold-off. In addition, for short pulse operation, waveguides with small cross-sectional areas may be subject to optical coatings' damage due to high intra-resonator peak powers.

It is therefore recognized that in order to provide higher output powers from diode-pumped slab waveguide lasers, the gain should be decreased by increasing the thickness of the slab, even while maintaining sufficiently large aspect ratio so as to benefit from favorable heat dissipation properties. By increasing the slab thickness to well beyond single mode dimensions it is no longer possible, however, to rely on waveguide properties to achieve single mode operation. Instead, hybrid resonator designs may be advantageously utilized to confer the advantage of high brightness outputs through judicious application of methods similar to those used for sealed-off CO₂ lasers. It is further recognized, however, that hybrid resonator designs for thin solid state slabs must be fundamentally different from discharge gas lasers with their much longer wavelengths. In particular, designs for 1 μm lasers cannot rely on mode discrimination properties present at 10 μm and also require special attention to circumvent potential damage effects, especially in Q-switched operation. On the other hand, although some of the prior literature on solid state waveguide lasers indicated the desirability of applying unstable resonator concepts, designs suitable for commercial exploitation have not yet been demonstrated. More particularly, most of the prior art planar waveguide lasers were constructed essentially for experimental purposes and little effort was expanded to overcome problems faced when attempting to operate the lasers at high power levels for extended periods of time. Neither are we aware of any prior demonstrations of short pulse operation from planar solid state waveguides operated in a Q-switched or mode-locked mode producing significant output pulse energies and average powers.

### SUMMARY OF THE INVENTION

It is therefore an object of this invention to provide a diode pumped solid state laser system providing high output power (>50 W) and a near diffraction-limited beam with a single active laser component without the need to restrict the useable pump power range.

Yet another object of this invention is to provide a diode-pumped solid state laser system, that provides high output power in a near diffraction limited beam and also provides pump light confinement through total internal reflection inside a composite dielectric slab structure or reflection off a coated slab surface.

It is another object of this invention to provide a diode pumped solid state laser system, with high output power in a near-diffraction limited beam in CW, Q-switched or modelocked operation by placing the appropriate optical devices inside the laser resonator.

There is a further object to provide designs for high power solid state laser that are compact and reliable enough to operate for extended periods of time with high degree of stability.

It is yet another object of the invention to provide multimode coated slab waveguides configured with hybrid geometries similar to CO₂ designs. It is recognized that such structures may be especially advantageous for lower gain and/or high threshold laser materials for which thinner dimensions are preferred. By exploiting the unique properties of coated waveguides whereby high order modes along the thin direction are substantially attenuated, it is possible to provide outputs in excess of 50 W with near diffraction limited beams from lasers that were not amenable to such operation using conventional bulk structures. In preferred embodiments the coated waveguide slabs are provided with hybrid resonators comprising a combination of stable and unstable configurations.

These and other objects of the invention are achieved in a diode pumped thin slab laser configured with new and improved hybrid resonator geometries such that output powers in excess of 50 W are feasible with near diffraction limited beams and high degree of stability in either CW or pulsed mode operation. Embodiments addressed in the present invention include coated multimode slab waveguide lasers as well as thin slab lasers which guide only the pump radiation. Preferably, hybrid resonator designs which include an unstable resonator in the wider dimension are provided. In the orthogonal, thin direction the resonator may be guided, stable or unstable. For high power applications, coated slab waveguide designs may be most useful for lower gain crystalline materials such as Yb:YAG, whereas thin slabs with high aspect ratios are more beneficially utilized for higher gain media such as Nd:YAG and Nd:YVO₄. Such slabs may be constructed either with appropriately applied coatings or sandwiched between suitably matched dielectric materials.

### DESCRIPTION OF PREFERRED EMBODIMENTS

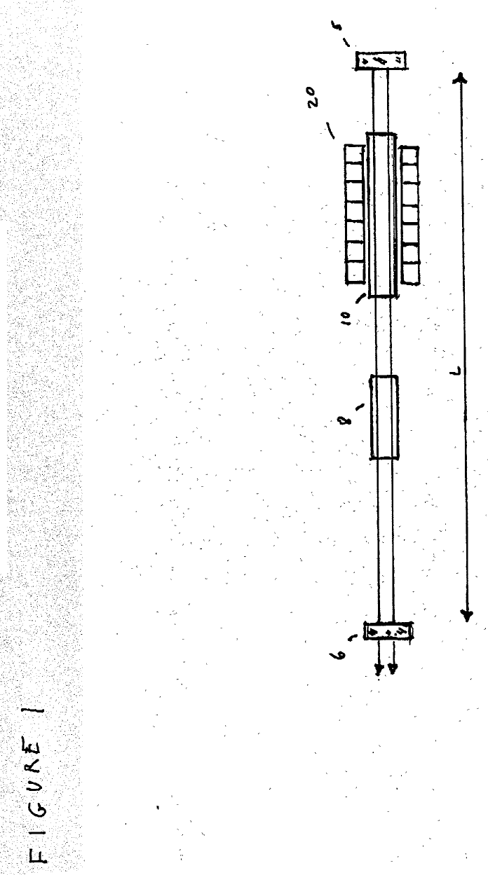

FIG. 1 illustrates schematically the diode-pumped slab laser 1 of the subject invention.

The resonator is defined by at least a high reflector 5 and an output coupler 6. A modulator 8 may further be incorporated within the resonator, which may be a Q-switch or mode locker. The gain medium 10 includes one or more sections of an optically active solid state material configured in the shape of rectangular slabs with a high aspect ratio. Pumping light from an emission line of semiconductor diode laser arrays, 20, is allowed to enter the slab through at least one of the slab's side faces. For high power applications pumping from two sides, using two sets of diode array stacks, may be utilized, as schematically shown in the embodiment of FIG. 1. The minimum aspect ratio is defined according to known scaling laws which govern thermal dissipation in solid media. Preferably, the aspect ratio is greater than 10 which assures near-one dimensional thermal gradient with temperature increases of less than a few degrees Celsius across the slab for most solid state gain materials of interest. The two largest opposing side faces of the slab are either coated with dielectric or metallic materials or are in contact with one or a stack of slabs of dielectric materials, as is described below. The side faces of the slab may be polished and AR coated at the solid state laser emission wavelength. The slab is thermally controlled by cooling its upper and/or lower side. Cooling methods may include direct water cooling, or conduction cooling through a metal structure that is in contact with the upper or lower slab side. When pumped through one or more of the smaller side faces, the pump light is guided inside the slab structure through total internal reflection or by reflection off the coated, larger side faces. Methods of fabrication of such composite structures to provide for pump guidance include cladding through ion implantation (see for example, the report by Hanna et al in Ref. 11 on ion implanted Yb:YAG planar waveguide), electric field assisted solid film diffusion, liquid film epitaxial (LPE) growth (see, for example Ref. 12), RF sputtering, and, more recently, thermal bonding of precision finished crystals. A particularly successful application of the later method that was demonstrated in a wide variety of solid state materials involves the approach of Adhesive-free bonding, as disclosed by Meissner in U.S. Pat. No. 5,846,638. These and other methods for fabricating planar thin slabs and waveguides are all incorporated by reference herein.

In contrast to similar crystalline slab structures proposed or demonstrated recently, the slab of active laser material that is the subject invention is preferably not dimensioned as a single mode waveguide in any direction. For high gain materials, including Nd:YAG, thicknesses may range from several 10's of microns to nearly 1000 μm, depending on material figure-of-merit parameter and incident pump power. The figure-of-merit is selected with due regard to fracture limits and attainable small signal gains prior to onset of ASE. Our analysis indicates that for pump powers in excess of 50 W, the slab thickness should be selected such that the small signal gain factor is preferably less than about 5. Under these conditions, resonator configurations may be optimized without regard to losses due to the effects of ASE and parasitics. In general, thinner slabs are preferably used in conjunction with lower gain materials such as Yb:YAG, Er:YAG or Tm, Er or Pr-doped fluoride crystals used in upconversion lasers (see for example, techniques taught in U.S. Pat. No. 5,805,631 and references cited therein for generating upconverted laser radiation from diode pumped fiber or waveguides).

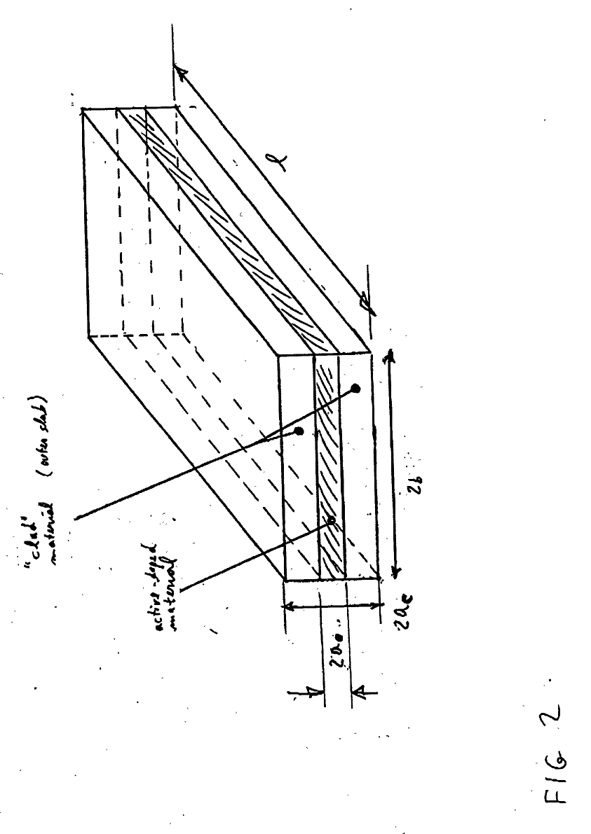

In one preferred embodiment, the active slab material is placed between two dielectric slabs with lower index of refraction as illustrated schematically in FIG. 2. Preferred dielectric materials for the outer two slabs are sapphire and quartz, which have been successfully bonded with a variety of doped crystalline materials. In a preferred embodiment the material of the two slabs that are in contact with the center slab are of the same material as the center slab, but have a different doping concentration or are undoped. A preferred method for joining the slabs relies on Adhesive-Free Bonding (AFB) technology successfully used to demonstrate numerous composite structures of doped and undoped solid state lasers. Slabs of different materials prepared according to this method are commercially available from Onyx, Inc. For example, with Nd:YAG as the active material, using sapphire as the outer slab, provides a numerical aperture of greater than 0.45. The three-slab sandwich can then be efficiently end- or side-pumped by diode bars with the pump light guided through total internal reflection to provide maximum absorption. Larger numerical apertures are generally preferred for optimal coupling of divergent pump light from standard diode arrays or diode array bars.

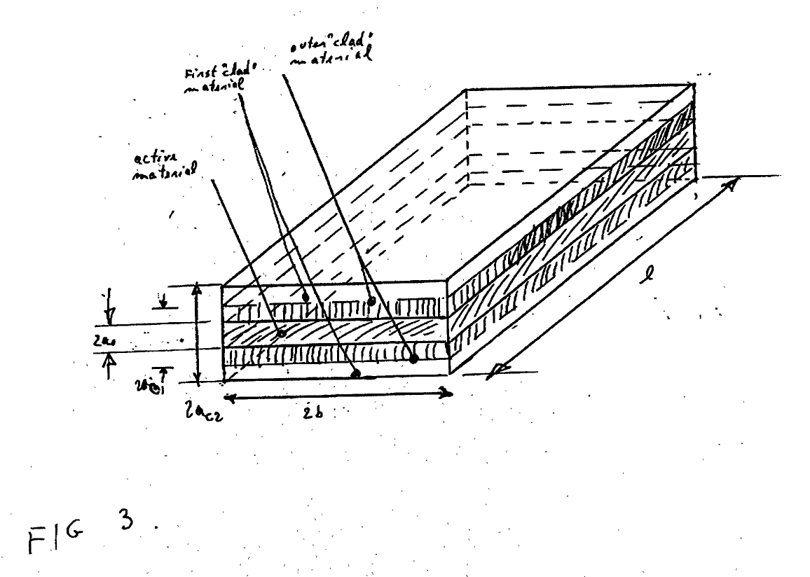

In another embodiment, the active slab material is placed between two stacks, each of which is comprised of two slabs of different dielectric materials as shown in FIG. 3. Generally, the inner slab comprise dielectric materials with a lower refractive index compared to the index of the active slab, while the outer slabs have a lower index of refraction relative to the inner slabs at the pump wavelength. This “double-clad” configuration has the advantage of reducing the sensitivity to position variations of pump light from the diode stacks. In addition, the index differences between the active material and the first stack may be selected to guide the signal while the second stack will guide the pump beam. In a preferred embodiment the material of the two slabs that are in contact with the center slab are again of the same material as the center slab, but have a different doping concentration or are undoped. Composite slabs of multiple different materials prepared in a “double clad” configuration according to the method of Adhesive-free Bonding are commercially available from Onyx, Inc.

It is noted, that the composite slabs prepared according to the “clad” configurations shown in FIGS. 2 and 3 above rely, in preferred embodiments, on free space propagation in all directions. In alternative embodiments, where the active center slab is thin enough to be a waveguide, it is multimode in nature, leading to multimode laser output. In still another alternative approach, a multimode waveguide may achieve single mode operation using waveguide constructions which employ metallic or dielectric coatings to allow maximum discrimination against higher order waveguide modes. The principles of such operation were well analyzed and the performance validated for CO₂ lasers. Since mode discrimination is proportional to the factor λ²/a³ where λ is the emission wavelength and a the waveguide thickness, coated waveguides may be especially advantageous for longer wavelengths active media, where single mode may be extracted waveguides that are not overly thin, and are therefore readily manufacturable. For example, in the case of erbium doped crystals with emission near 3 μm, a 500-700 μm thick waveguide slab may provide near single mode performance equivalent to that obtained from some well-established 1.5 mm thick CO₂ waveguide slab lasers, using similar resonator constructions. This cross section should improve the performance from many low gain Erbium (Er) or holmium (Ho) doped materials, yet it is large enough to allow application of suitable metal or dielectric coatings with standard techniques. Note that even for a 1 μm emitting material such as Yb:YAG, coated waveguides 300-400 μm thick, should be thin enough to promote lower order mode operation, again by analogy with CO₂ waveguide slab lasers.

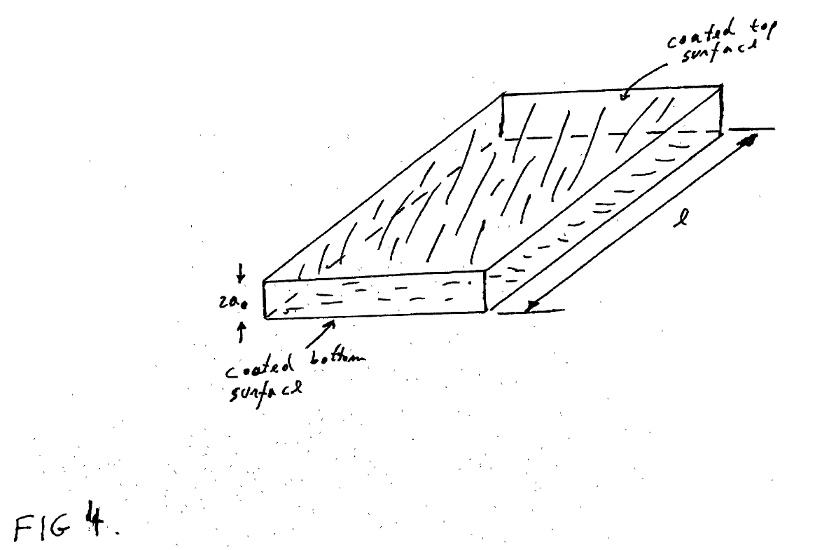

In accordance with the above, there is shown in FIG. 4 another embodiment wherein the two largest side faces (referred to as upper and lower sides) of the active slab material are coated with dielectric or metallic materials. The pump light is guided inside the slab through periodic reflections off these coated faces. The generic slab shown in FIG. 4 may consist of any one of known solid state gain materials, including but not limited to garnets, fluoride and oxide crystals doped with rare-earth ions such as Nd, Tm, Er, Ho, Pr and Tm. Preparation of said coated slab proceeds through the steps of polishing the large upper and lower sides of the slab and then coating them with a material (dielectric or metallic) that is highly reflective at the pump and emission wavelengths. The coatings are applied by standard techniques, such as sputtering.

As was shown in FIG. 1, the active laser component is placed inside a resonator, said resonator incorporating at least two mirrors. The laser may be operated in a CW mode, or alternatively, in a pulsed mode using and a Q-switch device. The resonator is designed to provide either a near diffraction limited output beam with M²<1.5 or a transverse multimode output beam with M² values between 1.5 and 30. In a preferred embodiment the resonator is a unstable resonator along the two larger slab sides that are perpendicular to the optical axis and a stable resonator along the two smaller slab sides that are perpendicular to the optical axis. In order to adapt the mode sizes along these slab sides to the slab dimensions, cylindrical resonator mirrors may be used. An output coupler with a graded reflectivity profile may further be used to improve the beam quality. In the orthogonal direction, a stable or flat-flat resonator may be sufficient to achieve good beam quality provided the thickness 2a of the medium is selected so as to generate a low Fresnel number, typically less than about 5. For single transverse mode operation, the Gaussian beam diameter in the slab, 2w, is preferably adjusted relative to the thickness of the slab according to the relation a <2w<3a. In accordance with the subject invention, the mirror separation, proximity to the waveguide and radii of curvature are selected based on desired output coupling, overall beam quality and required stability and physical size constraints, using customary resonator design selection criteria [1,2]. Either positive branch or negative branch resonator may be implemented, depending on gain material and resonator parameters.

### EXAMPLE 1

### Embodiment With Positive Branch Unstable Resonator

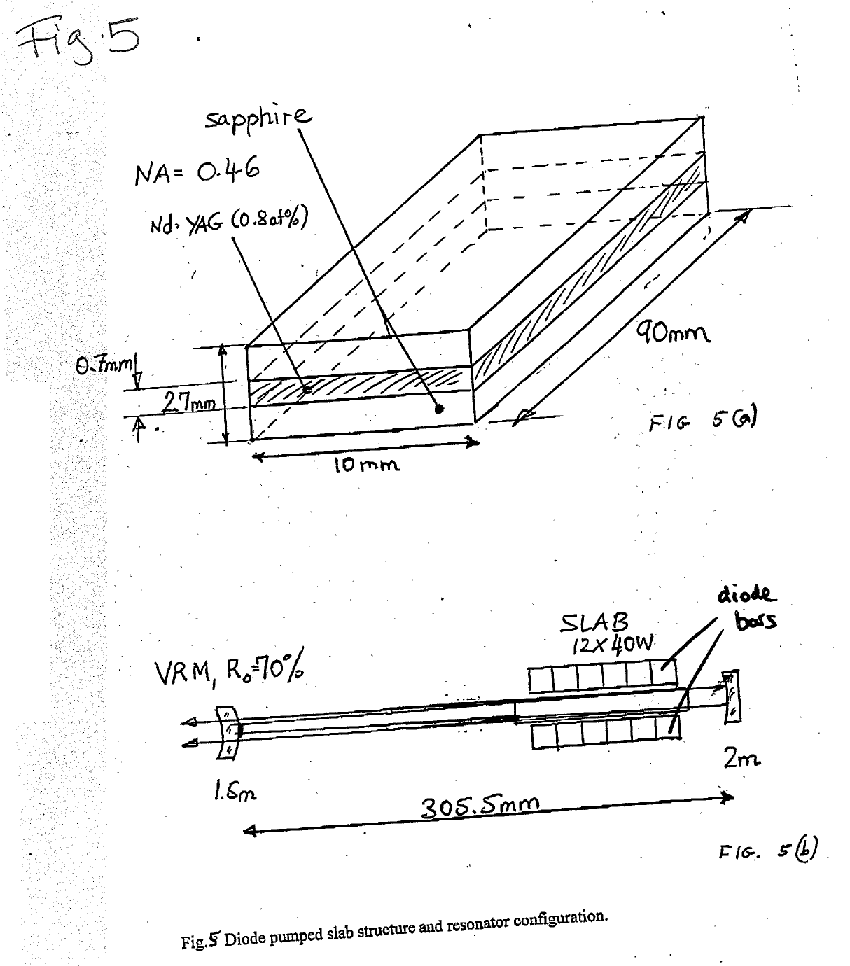

As shown in FIG. 5, a thin 0.8% Nd-doped YAG slab is cladding-pumped by 12 stacks of 40 W diode bars. The cladding is provided by sapphire slabs contact-bonded to the Nd:YAG. The dimensions of the active slab are selected as 0.7×10×90 mm long. A 2.5-3.0 mm width of the outer clad structure provides a numerical aperture >0.4, sufficient to couple radiation from the diode bars with over 90% efficiency. The resonator comprises a convex output coupler (OC) mirror and a concave or flat high reflecting (HR) mirror. The optics are cylindrical so as to accommodate the asymmetric properties of the hybrid resonator. Thus, in the small direction, the mirrors have long radii of curvature defining a stable resonator. The curvatures and the distances of the mirrors from the slab are selected according to known principles of Gaussian beam mode matching, and including the effect of thermal lens of the slab, such that only low order mode will couple efficiently into the slab. For the slab dimensions used in this example, a resonator length of 30.5 cm and mirror curvatures of 2 m and 1.5 m for the HR and the OC mirrors respectively were found to provide good mode discrimination against higher order modes.

In the orthogonal direction, the output coupler defines a variable reflectivity mirror (VRM) known from the art of unstable resonators design. A VRM exhibits a supergaussian reflectivity profile conventionally expressed as:

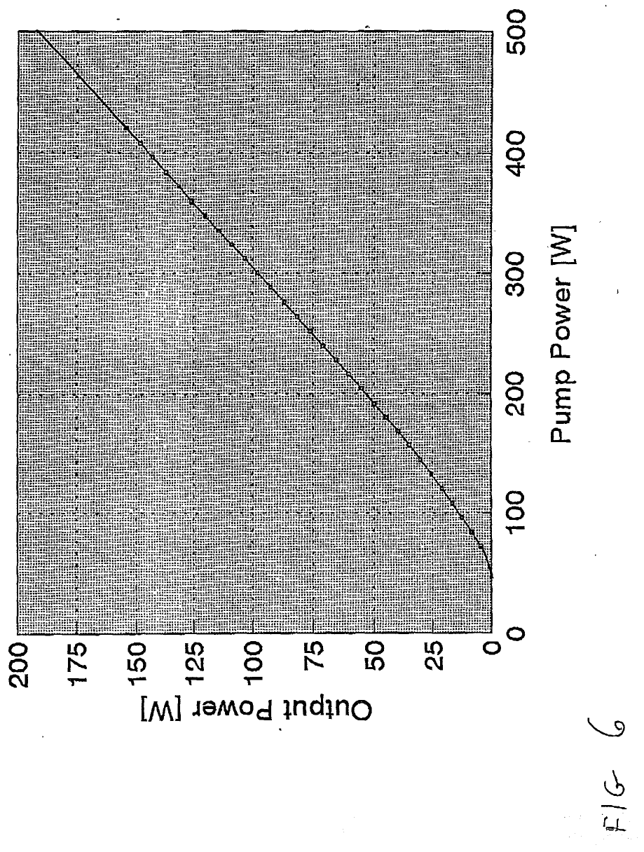

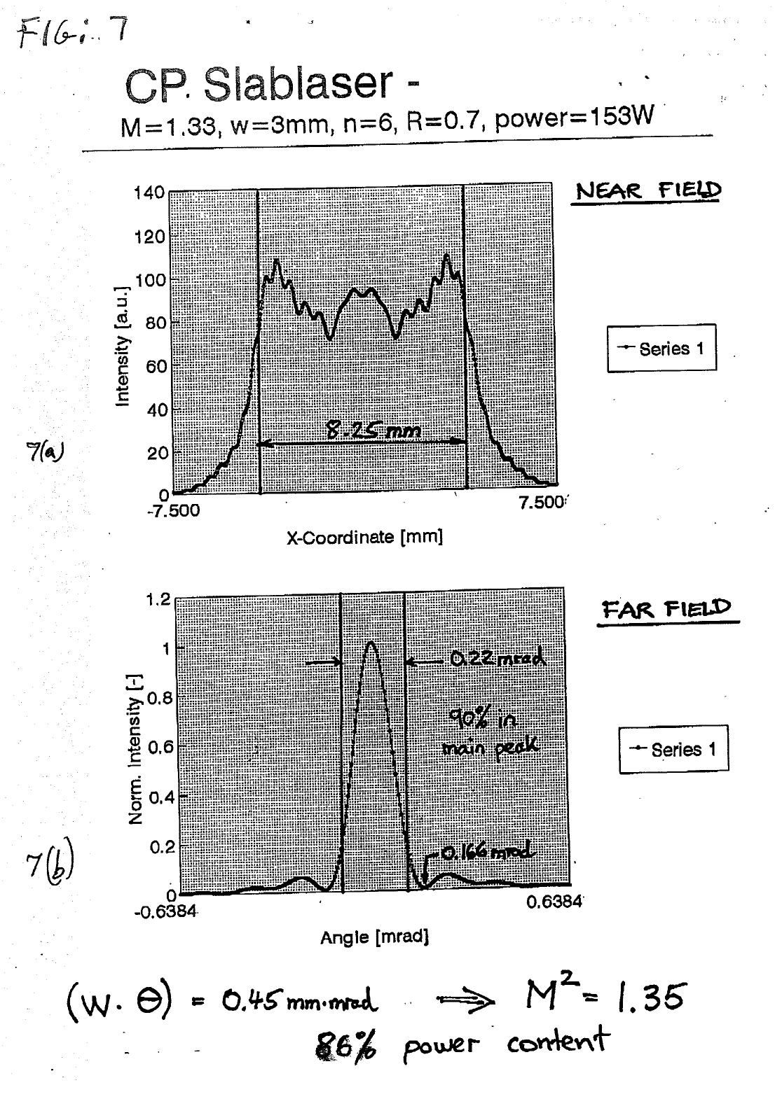

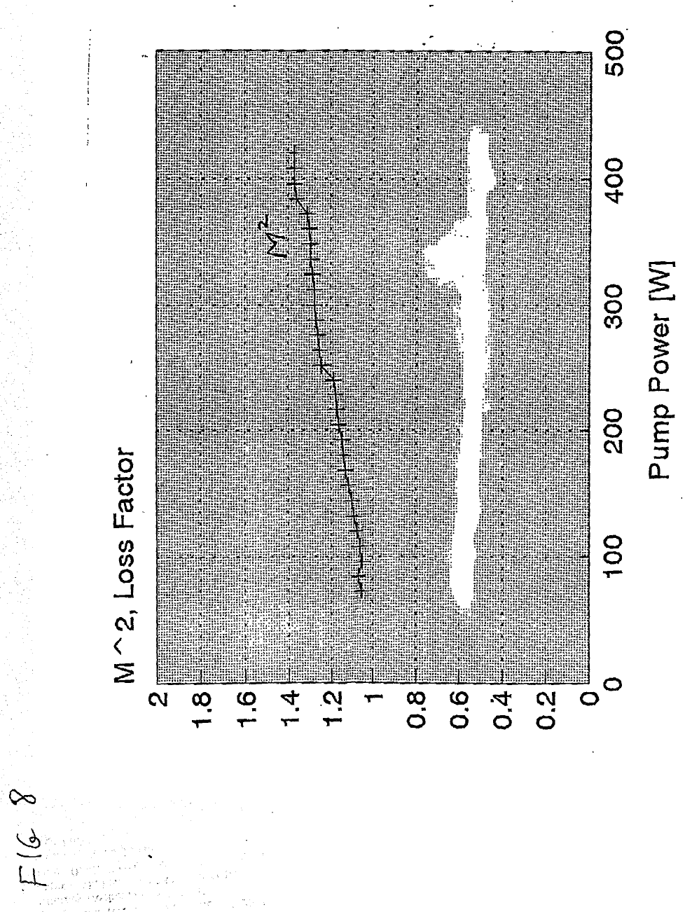

R(x)=R₀ exp{−2(x/w)ⁿ}

Where R₀ is the center reflectivity, w is the profile radius, n is the super-gaussian index and x is the coordinate along the wide slab dimension. FIG. 6 shows a plot of the projected output power as a function of the input power in Watts for R₀=0.7, n=6, magnification of 1.33, and output coupling of 52.5%. FIG. 7 shows the beam intensity profiles for w=3 mm along the x-coordinate in the near (FIG. 7a) and far-field (FIG. 7b) at an output power of 150 W. With this choice of parameters, 90% of the far field power content s seen to be in the main peak, corresponding to a beam quality parameter M² of 1.35. FIG. 8 shows the variation in M²as a function of the pump power, indicating only slight increase even for powers levels exceeding 400 W. Thus, output beam from the hybrid resonator has a somewhat asymmetric beam divergence with M² ranging from about 1.1 to 1.5 corresponding to the stable and unstable axis, respectively. The asymmetry can be compensated by using cylindrical optics external to the resonator.

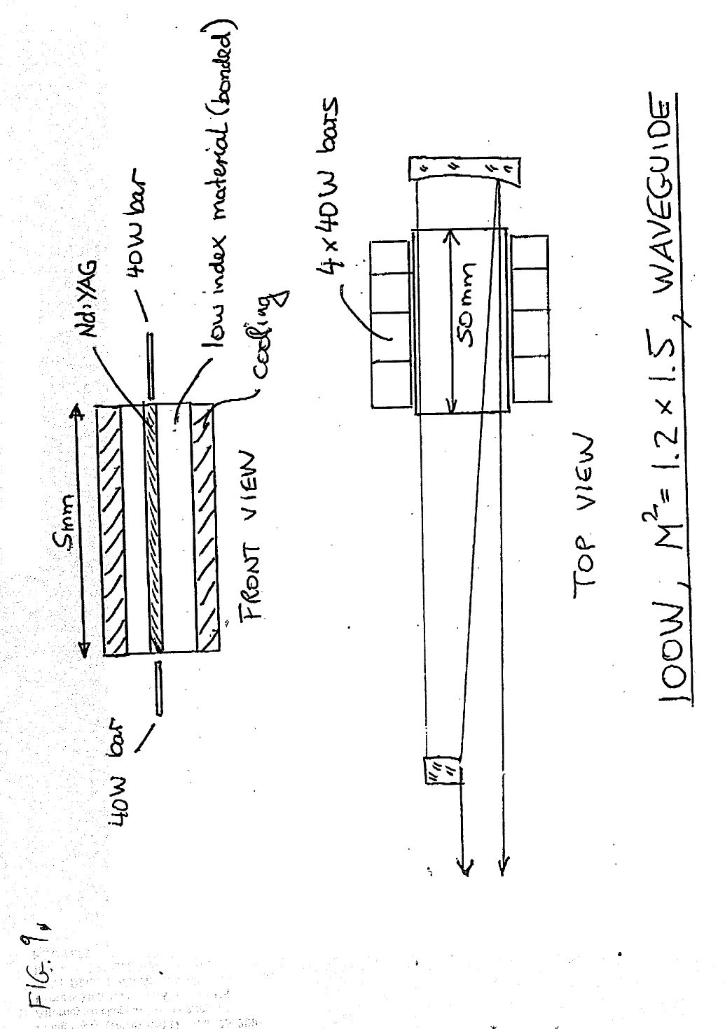

Note that although the above construction utilizes a positive branch unstable resonator, alternative constructions based on negative branch design may be employed in certain cases. While negative branch resonators are known to provide better stability characteristics, they can present some difficult design issues. Among other problems, an intracavity focus, can lead to overly long resonators as well as degraded spatial beam profiles. Folded cavities can however be implemented to reduce the physical size at some added cost in optical complexity, as is known from the art of resonator design [2]. It is further noted that while negative branch hybrid resonators have been used successfully for CO₂ slab waveguide lasers, implementation for solid thin slab materials has not been disclosed prior to the present invention. These and other similar and alternative resonator and cavity configurations known from the art of laser design fall within the scope of the present invention. These include an off-axis resonator an example of which is shown in FIG. 9 for a solid state thin slab laser.

### EXAMPLE 2

### Pulsed Thin Slab Laser

The invention includes Q-switched and mode-locked operation wherein the modulator shown in FIG. 1 is selected from a class of electro-optic or acousto-optic switches.

### EXAMPLE 3

### 3 μm Multimode Waveguide Slab Laser

Another preferred embodiment involves operation at 3 μm as obtained, typically from Er and Ho doped materials. Since these are known to have relatively low gains and high thresholds, thin slab constructions with a very small dimension are advantageously utilized. One example, an Er:YAG slab with a thickness that is less than about 0.6 mm is constructed as a metallic or ceramic coated rectangular slab. At this wavelength, multimode guiding of the signal is achieved along the thin dimension. Single mode operation can however be obtained by exploiting mode discrimination properties using stable resonator design properties similar to those previously implemented for CO₂ waveguide lasers. Although the application of such principles for mode discrimination were known for prior art hybrid resonators for gas lasers, the waveguide structure provided in this invention does not follow prior art teachings for solid state waveguide structures, and therefore represents a novel application of techniques and constructions disclosed in the present invention.

What is claimed is:

1. A laser, comprising:
a first reflector;
a second reflector spaced apart from the first reflector to form an optical cavity therebetween, the optical cavity having a characteristic optical axis passing through the first and second reflectors;
a gain medium disposed between a first set of slabs of first dielectric material, wherein an interface of the gain medium and the slab material define a first optical waveguide for pumping radiation having a first guiding direction substantially perpendicular to the characteristic optical axis passing through the first and second reflectors;
a second set of slabs of a second dielectric material, the gain medium and the first set of slabs disposed therein, wherein an interface between the first and second slabs defines a second optical waveguide having a second guiding direction substantially parallel to the characteristic optical axis passing through the first and second reflectors; and
a pump source optically coupled to the first optical waveguide.
